(19) United States
(12) Patent Application Publication
(10) Pub. No.: US 2003/0079788 A1
(43) Pub. Date: May 1, 2003

(54) Preformed channel for piping system

(75) Inventors: Robert F. Egan, Keene, NH (US); Cortez White, Rockville, MD (US)

Correspondence Address: FINNEGAN, HENDERSON, FARABOW, GARRETT &, DUNNER LLP, 1300 I STREET, NW, WASHINGTON, DC, 20006, US

(73) Assignee: CityNet Telecommunications, Inc.

(21) Appl. No.: 10/278,068

(22) Filed: Oct. 23, 2002

Related U.S. Application Data
(62) Division of application No. 09/722,034, filed on Nov. 27, 2000.
(60) Provisional application No. 60/231,935, filed on Sep. 12, 2000.

(51) Int. Cl. F16L 9/18

(52) U.S. Cl. 138/112; 138/113; 138/155

(57) ABSTRACT

This invention related to a pre-formed channel piping system. This invention relates to a pre-formed channel piping system to facilitate a combination utility fluid system with an underground communication network. The pre-formed fluid pipes include a channel for carrying communication components in a protected casing.

This application claims the benefit under 35 U.S.C. § 119, of provisional application 60/231,935 filed Sep. 12, 2000, titled Pre-Formed Channel for Piping System.

### DESCRIPTION OF THE INVENTION

1. Field of the Invention

This invention related to a pre-formed channel piping system. This invention relates to a pre-formed channel piping system to facilitate a combination utility fluid system with an underground communication network.

2. Background of the Invention

Infrastructure deployment traditionally has been based on the theory that each separate use, i.e., sanitary sewer, water, natural gas, oil, petroleum, electricity, cable T.V., telecommunications, or other signaling functions should have its own right-of-way separate from other facilities. One disadvantage of this approach is that over time, a plethora of facilities have been installed in city right-of-ways to such a degree that it is impractical to provide new services due to a lack of physical space for deployment.

It has been proposed to place conventional technology communication cables into the interior of existing utility fluid pipes utilizing, for example, an inner-duct lining within the outer duct, and robotics technology to install such an underground communication network. However, due to an aging infrastructure, growth in population and commercial development, and legal mandates, much of the nations existing utility fluid infrastructure is being replaced or expanded, thus, creating a need for a technology in applications where new infrastructure is being installed or replacing old infrastructure.

Therefore, there is a need for a new piping system and products that enable the installation of multiple use technology in a joint and common right-of-way thereby reducing the physical space needed to install and maintain infrastructure.

### SUMMARY OF THE INVENTION

The present invention relates to pre-formed pipe which includes a main channel and a channel for communication components. Embodiments of the present invention include the pre-formed pipes, a system of the pre-formed pipes, communication components, and a method of installing the system.

In accordance with the invention, an embodiment of the invention includes a pre-formed pipe comprising a plurality of substantially parallel, hollow, connected, elongated bodies; wherein at least one of the bodies is for carrying communication components.

In accordance with the invention, an embodiment of the invention includes, a pre-formed combined fluid channel and communication channel apparatus comprising: an elongated hollow body for channeling the flow of fluid; an elongated hollow communication channel connected to, and extending along, the body for channeling the flow of fluid.

In accordance with the invention, another embodiment of the invention includes a pre-formed communication channel connecting apparatus comprising: a coupling structure, wherein the connecting apparatus connects a first elongated hollow communication channel connected to, and extending along, the body for channeling the flow of fluid, to a second elongated hollow communication channel connected to, and extending along, the body for channeling the flow of fluid.

In accordance with the invention, another embodiment of the invention includes a system of combined, pre-formed fluid channels and pre-formed communication channels comprising: a plurality of elongated hollow bodies for channeling the flow of fluid; at least one elongated hollow communication channel extending along the elongated length of the hollow bodies channeling the flow of fluid; connections between hollow bodies channeling the flow of fluid; and connections between the communication channels.

In accordance with the invention, another embodiment of the invention includes a method of installing a communication network comprising the steps of: installing pre-formed fluid channels with pre-formed communication channels; connecting fluid channels to other fluid channels; connecting communication channels to other communication channels; and installing the communication network in the communication channels.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a perspective view of a main channel pre-formed pipe having one sub-channel consistent with the principles of the present invention;

FIG. 2 is a perspective view of a main channel pre-formed pipe having multiple sub-channels consistent with the principles of the present invention;

FIG. 3 is a section view of a pair of pre-formed pipe channels connected by a channel connector consistent with the principles of the present invention;

FIG. 4 is an end view of the connected pre-formed pipe channels shown in FIG. 3;

FIG. 5 is a perspective view of the channel connector; and

FIG. 6 is a perspective view of a pair of pre-formed pipe channels connected by a double-bead fusion joint consistent with the principles of the present invention;

FIG. 7 is a perspective view of another embodiment of a pre-formed pipe channel having multiple sub-channels consistent with the principles of the present invention; and

FIG. 8 is an end view of a pre-formed pipe with a non-circular cross section with communication channels embedded into the walls of the fluid channel.

### DESCRIPTION OF THE PREFERRED EMBODIMENTS

Reference will now be made in detail to the present preferred embodiments of the invention, examples of which are illustrated in the accompanying drawings. Wherever possible, the same reference numbers will be used throughout the drawings to refer to the same or like parts.

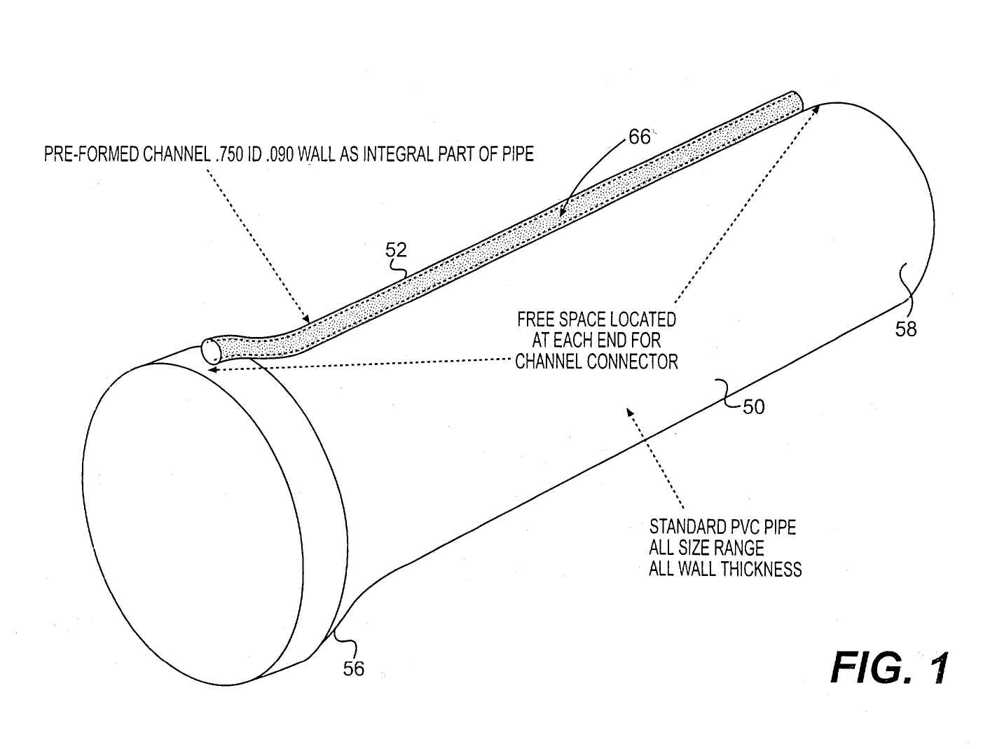

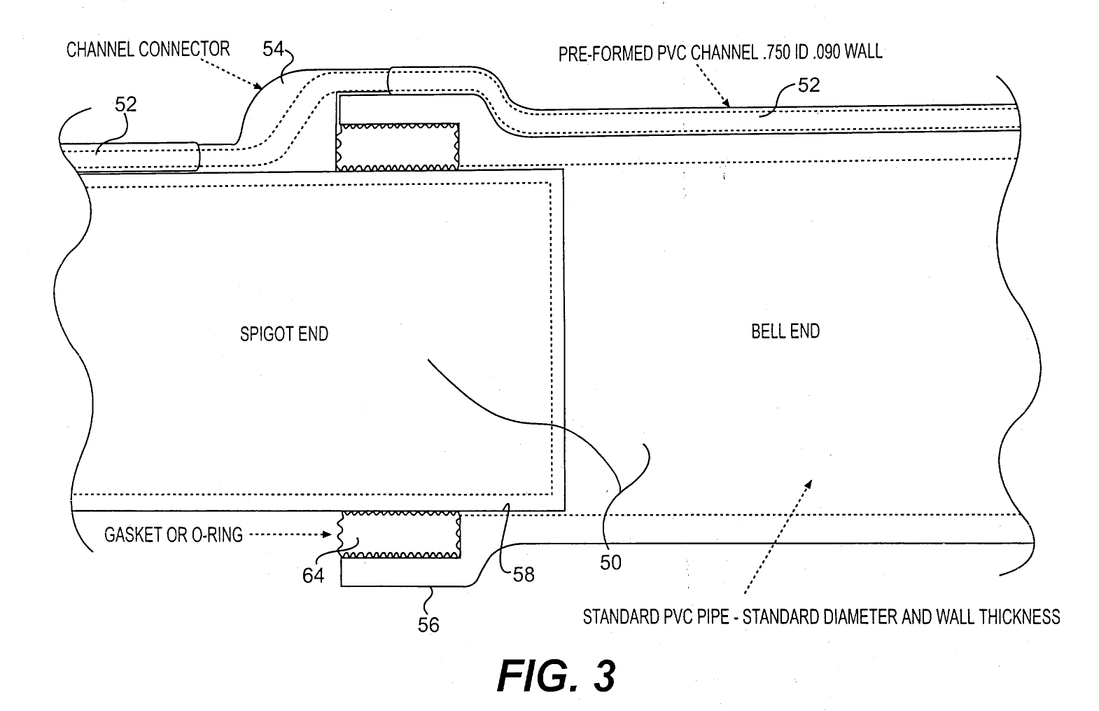

In accordance with the invention, the present invention includes a pre-formed pipe including a plurality of substantially parallel, hollow connected, elongated bodies. With reference to FIG. 1, the main pipe (50) is a long, hollow, elongated body with a second, smaller diameter, hollow, elongated body (52) located on the periphery of the pipe (50). In the preferred embodiment, each length of main pipe (50) has two ends. Preferably, one end of the main pipe is a bell shaped receiving end (56) and the other end is a strait spigot end (58) to facilitate the connecting of the main pipe (50) to other sections of main pipe. FIG. 3 shows the spigot end (58) of one pipe (50) and the bell end (56) of another pipe (50) fitted together and sealed with an O-ring gasket (64) Preferably, the larger diameter main body (50), also called the main pipe, is for channeling utility fluids such wastewater, storm water, other sanitary sewer and drain applications, oil, natural gas, petroleum, or other utilities. The smaller diameter body (52) also referred to as a communication channel, is for carrying communication components (66) for such uses as telecommunications, internet, Scientific Control and Data Acquisition (SCADA), Fire Alarm, Security Alarm, Traffic Signaling Facility training/locating wire, cable T.V. or other electronic circuit or data transmission components. These components (66) can be common copper communications wire, copper tone tracer wires, fiber optic cables, co-axial cables, or any other communications carriers lending themselves for this type of installation application.

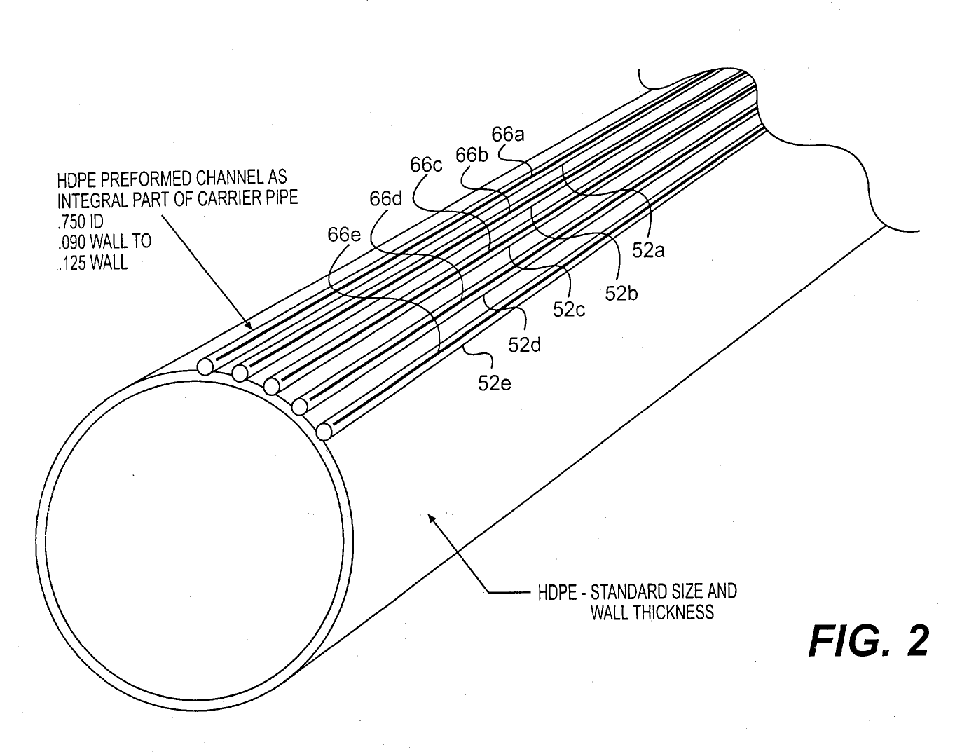

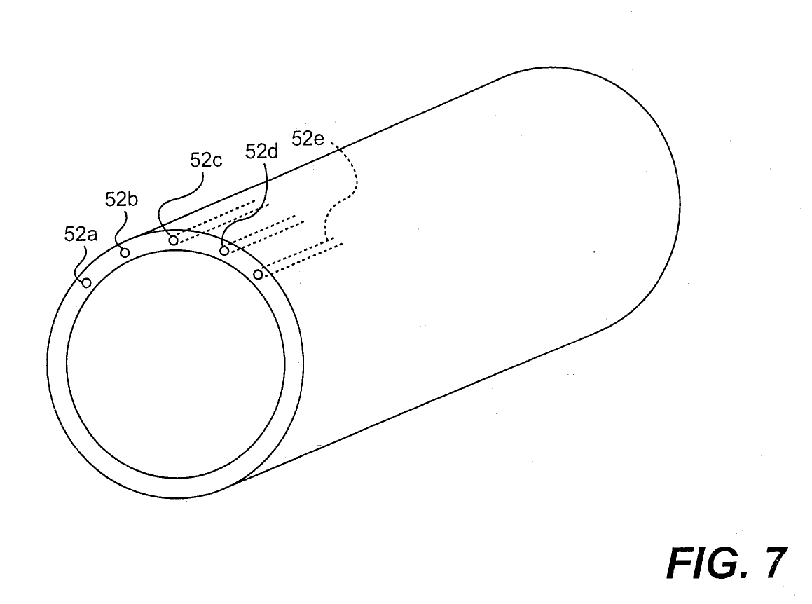

In some embodiments of the invention, the main pipe (50) may be pre-formed to have more than one communication component carrying body (52a-e), as shown in FIGS. 2 and 7. A plurality of communication component carrying bodies (52a-e) may be pre-formed with the main pipe (50) according to the anticipated use of the pipe and communication channels.

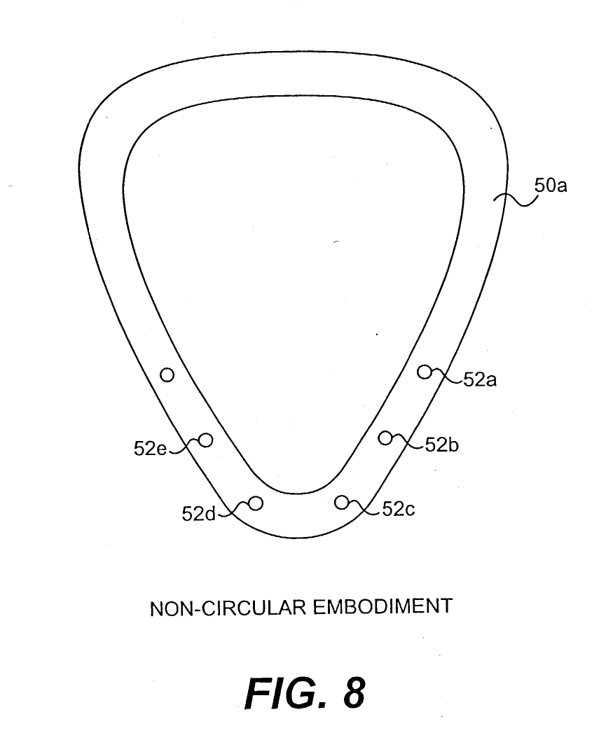

In the preferred embodiment of the invention, the main pipe (50) is approximately tubular, but in other embodiments as in FIG. 8 the main pipe (50a) may have other cross sectional shapes.

In the preferred embodiment of the invention, the pipe (50) and the communication carrying bodies (52a-e) are pre-formed in such a way that the communication carrying bodies (52a-e) are located outside of the main pipe (50) as embodied in FIGS. 1-4 and 6. In other embodiments of the invention, the communication carrying bodies (52a-e) are located to the inside of the main pipe (50). In still other embodiments of the invention, the communication carrying bodies (52, 52a-e) are embedded into the walls of the main pipe (50) as embodied in FIG. 7 and 8.

The main pipe (50) and the communication channel (52) may be constructed of a variety of materials commonly known in the pipe art. Depending on the application and environment of use different materials may be used to construct the main pipe (50) and communication channel (52). Examples of possible suitable materials are, concrete, stainless steel, Polyvinyl Chloride (PVC), polyethylene (PE), or any suitable plastics. In some embodiments of the invention, the main pipe (50) and the communication channel (52) will be constructed of the same material, but in other embodiments the materials may be different such as a concrete main pipe (50) and stainless steel communication channels (52a-e) as shown in FIG. 7. Care should be taken to ensure that the materials used are compatible with the use of the main pipe and communication channel.

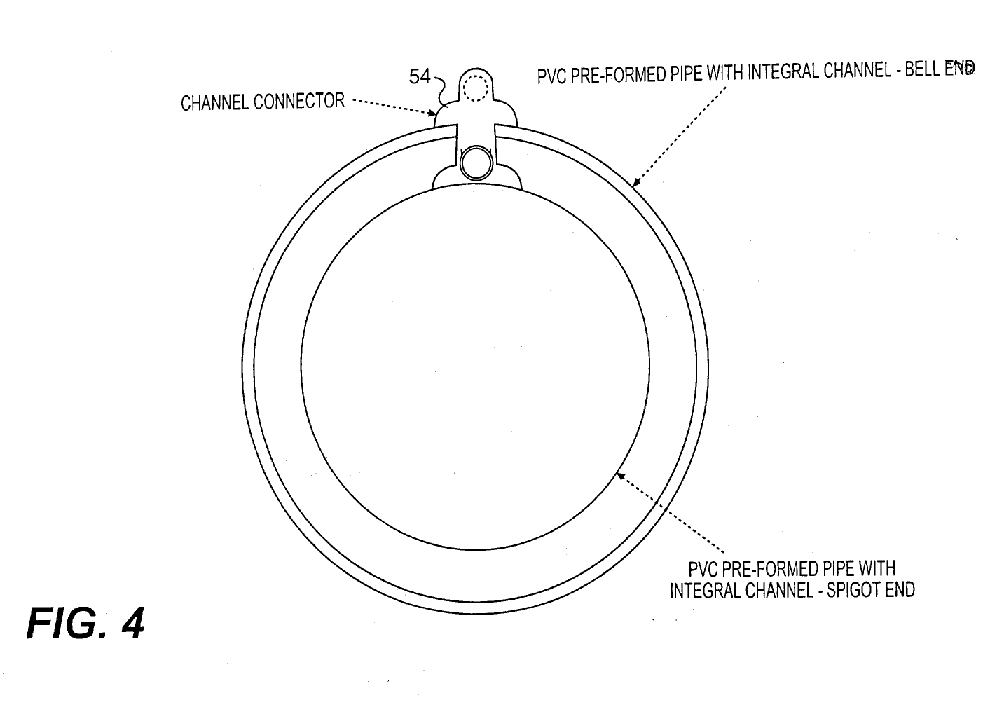

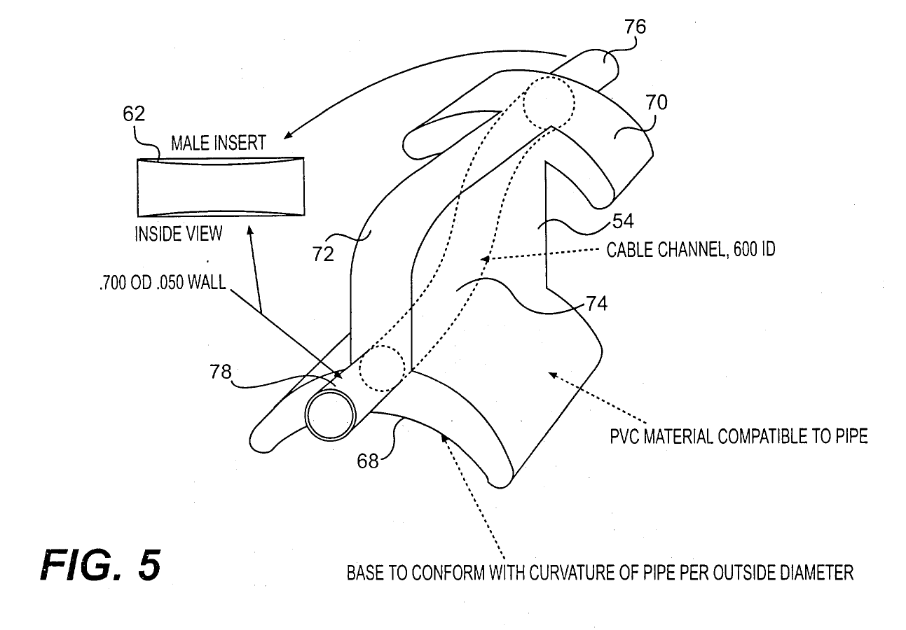

Because the invention includes a system of combined pre-formed fluid channels and communication channels, the invention includes communication channel connecting apparatus (54). In the preferred embodiment of the invention, shown in FIG. 5, the connecting apparatus (54) comprises a saddle shaped base (68) for attaching to the main pipe (50) (not shown in FIG. 5) a second saddle shaped base (70) for attaching to the communication channel (52) (not shown in FIG. 5), a brace structure (72), a connecting communication channel (74), a spigot end connecting structure (78), and a bell end connecting structure (76). Preferably, the spigot end connecting structure (78) connects to a communication channel (52) on the spigot end of a preferred pipe. The bell end connecting structure (76) connects to a communication channel (52) at the bell end of a preferred pipe. The brace (72) is preferably connected to the connecting communication channel (74). The preferred connecting apparatus (54) is used to connect the communication channels (52) of the preferred pipe system incorporating a standard bell (56) and spigot (58) joint design as illustrated in FIGS. 3 and 4. Preferably, a gasket or O-ring (64) as shown in FIG. 3 is used to seal the connection of two lengths of main pipe (50). Preferably, the communication channel connecting apparatus (54) includes a channel connector (shown in FIG. 5) as a way of connecting the channels to form a complete path for the installation of communication cables. The channel connector (54) is designed to conform to the curvature of the main pipe which can include channeling around the bell end (56) of the main pipe, and is preferably secured in place with adhesives applied the saddles (68, 70), and attaching the saddles (68, 70) to a main pipe (50) and a communication channel (52). The selections of adhesives may depend on the types of materials used to manufacture the main pipe (50) and communication channels (52). For example, a PVC adhesive may be suitable when the main pipe (50) and communication channels (52) are made of PVC.

To accommodate the installation of the channel connector (54) such that the channels (52), in concert with the connector (54), form a complete air tight or water tight path, the channel connector (54) is equipped with thin walled protrusions (62), referred to as male inserts, which serve to align the channel connector (54) to the channels (52). The protrusions (62) are designed with a taper to minimize obstruction during a shuttle leader and cable installation in the channel system.

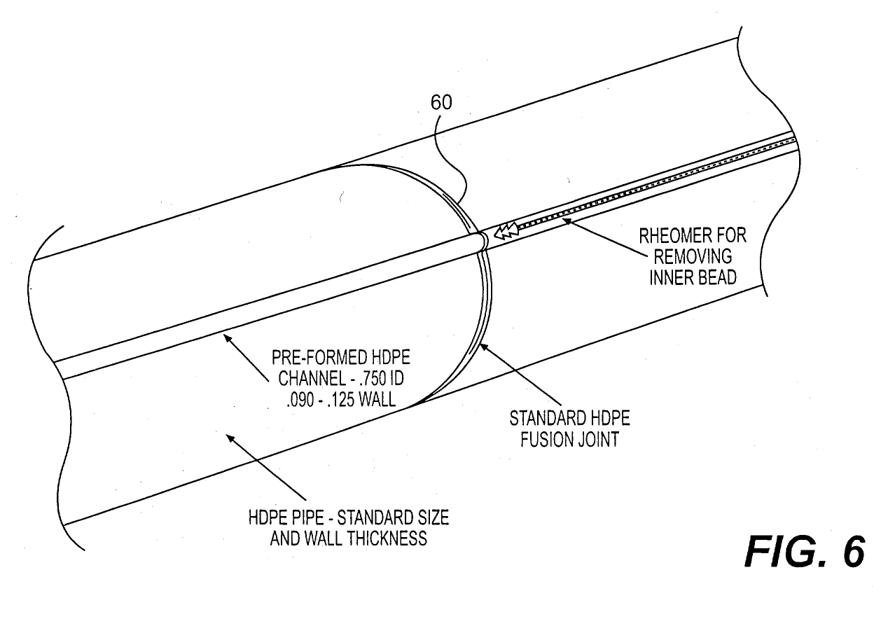

Alternatively, a conventional double-bead fusion joint (60), such as the type commonly used in a gas piping industry, may be used to connect each main pipe to a subsequent one to construct the piping network as shown in FIG. 6. In other embodiments of the invention, chemical bonding or heat welds may form the connection of a main pipe (50) to a main pipe (50) and a communication channel (52) to a communication channel (52). Other embodiments of the invention will make these connections with other modes of connection commonly known in the art.

In accordance with the present invention, the invention includes a method of installing a communication network. The method includes several steps including installing the pre-formed main pipes (50) and pre-formed communication channels (52). These are installed using traditional pipe laying techniques of digging, and placing the pipe. The method further includes connecting the main fluid channels to other sections of main fluid channels and communication channels to other communication channels. In order to properly install and connect the channels, often the spigot end of the main pipe (50) needs to be cut to the proper length for the environment where it is to be deployed. In such cases, it is preferred to cut and remove the channel to a location sufficient from the end of the pipe to allow installation of the channel connector (54) This action can be accomplished by using a hand or power equipment in a manner which does not interfere with the integrity of the carrier pipe. The exterior pipe wall exposed as a result of the removal of the excess channel should be filed or ground to approximate the natural curvature of the pipe such that when applied, the channel connector forms a good bond to the pipe.

In accordance with the present invention, the communication network is installed in the communication channels. Once the pipe system has been installed such that the pipe structure forms continuous paths for both the main channel and the communication channels, traditional cable pulling techniques can be employed to install the communications cable. An example of which is blowing a shuttle leader with attached cable though the communication channels.

Applications of the principles of the present invention may result in long term lease opportunities with multiple use technology which can be installed over time without utilizing traditional and capital intensive open road cut methods. The system allows the flexibility to install communication facilities as needed to meet the diverse communications needs in an evolving marketplace. Applications of the invention will save significant labor and materials costs in situations where new pipe is required.

The potential advantages of a single structure for multiple technological uses include, among others, less cross sectional area requirements in an already over burdened underspace, financial savings due to shared right-of-way, financial savings associated with common location pertinent to underground damage prevention programs, and reduced construction costs. The products combine into a single application commonly used materials which have proven compatibility with their respective applications. One aspect of the invention facilitates the installation of a single pipe structure to be utilized in common sanitary sewer and other utility fluid applications in conjunction with the conveyance or application of, for example, telecommunications, internet, Scientific Control and Data Acquisition (SCADA), Fire Alarm, Security Alarm, Traffic Signaling, facility tracing/locating wire, or other electronic circuit or data transmission.

The products manufactured consistent with the principles of the present invention are ideally suited for large metropolitan areas where minimal infrastructure construction activity can have a major impact on the residents, commercial establishments, and the environment. The invention will assist in deployment of fiber optic and co-axial cable and other communication components in locations where existing sanitary sewer, drain piping, or other fluid utilities are being replaced and in locations where no previous utility fluid pipe existed.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A pre-formed pipe comprising;
a plurality of substantially parallel, hollow, attached, elongated bodies:
wherein at least one of the bodies is for carrying communication components and at least one of the bodies is for carrying utility fluid.

2. The pre-formed pipe of claim 1, wherein the body for carrying utility fluid has a bell shaped receiving structure at one end and a strait spigot at an other end.

3. The pre-formed pipe of claim 1, wherein a body for carrying communication components is attached to the outside of the body for carrying utility fluid.

4. The pre-formed pipe of claim 1, wherein a body for carrying communication components is attached to the inside of the body for carrying utility fluid.

5. The pre-formed pipe of claim 1, wherein a body for carrying communication components is embedded in the wall of the body for carrying utility fluid.

6. The pre-formed pipe of claim 1, wherein there is a plurality of bodies for carrying communication components.

7. The pre-formed pipe of claim 1, wherein the body for carrying utility fluid has a cross section geometry shape other than a circle.

8. The pre-formed pipe of claim 1, further comprising communication components in the communication channel.

9. The pre-formed pipe of claim 8, wherein the communication components include at least one of; fiber optic cable, co-axial cable, electrical cable.

10. A pre-formed combined fluid channel and pre-formed communication channel apparatus comprising:
an elongated hollow body for channeling the flow of fluid;
an elongated hollow communication channel connected to, and extending along, the body for channeling the flow of fluid.

11. The pre-formed combined fluid channel and pre-formed communication channel apparatus of claim 10, wherein the fluid channel has a bell shaped receiving structure on one end and a strait spigot shape on an other end.

12. The pre-formed combined fluid channel and pre-formed communication channel apparatus of claim 10, wherein the communication channel attached to the outside of the fluid channel.

13. The pre-formed combined fluid channel and pre-formed communication channel apparatus of claim 10, wherein the communication channel attached to the inside of the fluid channel.

14. The pre-formed combined fluid channel and pre-formed communication channel apparatus of claim 10, wherein the communication channel is embedded into the wall of the fluid channel.

15. The pre-formed combined fluid channel and pre-formed communication channel apparatus of claim 10, wherein there is a plurality of communication channels.

16. The pre-formed combined fluid channel and pre-formed communication channel apparatus of claim 10, wherein the cross section geometry of the fluid channel is a shape other than a circle.

17. The pre-formed combined fluid channel and pre-formed communication channel apparatus of claim 10, further comprising communication components in the communication channel.

18. The pre-formed combined fluid channel and pre-formed communication channel apparatus of claim 17 wherein the communication components include at least one of; fiber optic cable, co-axial cable, or electrical cable.

19. A communication channel connecting apparatus comprising:
a coupling structure, wherein the connecting apparatus connects a first elongated hollow communication channel connected to, and extending along, the body for channeling the flow of fluid to a second elongated hollow communication channel connected to, and extending along, the body for channeling the flow of fluid.

20. The communication channel connecting apparatus of claim 19, wherein the connecting apparatus attaches to the fluid channel.

21. The communication channel connecting apparatus of claim 19, wherein the connecting apparatus provides a connection to the communication channel around the curvature of the fluid channel bell shape.

22. The communication channel connecting apparatus of claim 19, further comprising inserts wherein the inserts align the channel connector to the communication channel.

23. The communication channel connecting apparatus of claim 22, wherein the inserts are tapered to minimize obstructions in the channel and connection apparatus.

24. The communication channel connecting apparatus of claim 19, further comprising one of:
a saddle shaped base to attach, to a body for channeling the flow of fluid;
a second saddle shaped base to attach to a communication channel; and
a brace structure.

25. The communication channel connecting apparatus of claim 19, wherein the apparatus includes a bonding agent.

26. A system of combined, pre-formed fluid channels and pre-formed communication channels comprising:
a plurality of elongated hollow bodies for channeling the flow of fluid;
elongated hollow communication channels extending along the elongated length of the hollow bodies channeling the flow of fluid;
connections between hollow bodies channeling the flow of fluid; and
connections between the communication channels.

27. The system of claim 26, further comprising communication components located in the communication channels.

28. The system of claim 27, wherein, the communication components included at least one of; fiber optic cable, co-axial cable, or electrical cable.

29. A method of installing a communication network comprising the steps of:
installing pre-formed fluid channels with pre-formed communication channels;
connecting fluid channels to other fluid channels;
connecting communication channels to other communication channels; and
installing the communication network in the communication channels.

30. The method of claim 29, wherein the fluid channels and communication channels are installed underground.
